(19) United States
(12) Patent Application Publication
(10) Pub. No.: US 2018/0005191 A1
(43) Pub. Date: Jan. 4, 2018

(54) METHOD AND SYSTEM FOR RANKING QUESTIONS FOR JOB INTERVIEW

(71) Applicant: XEROX CORPORATION, Norwalk, CT (US)

(72) Inventors: Asmita Metrewar, Nanded (IN); Savitansh Srivastava, Hyderabad (IN); Partha Dutta, Bangalore (IN)

(21) Appl. No.: 15/197,811

(22) Filed: Jun. 30, 2016

(51) Int. Cl. G06Q 10/10; G06F 3/0482; G06F 17/30; H04L 29/08

(52) U.S. Cl. CPC G06Q 10/1053; H04L 67/306; G06F 3/0482; G06F 17/3053; G06F 17/30554

(57) ABSTRACT

The disclosed embodiments illustrate methods and systems for ranking a plurality of questions for a job interview. The method includes determining, for a question from the plurality of questions, a first score based on at least metadata associated with a job-profile, and a candidate-profile. The method further includes determining, for the question, a second score based on at least a count of responses to the question associated with previous interviews. The method further includes determining, for the question, a third score based on at least a selection of the question by interviewers in the previous interviews. The method further includes ranking each of the plurality of questions based on at least a weighted sum of the first score, the second score, and the third score. Further, the method includes displaying the ranked plurality of questions, based on at least a preference of an interviewer for the plurality of questions.

### TECHNICAL FIELD

The presently disclosed embodiments are related, in general, to a job interview assistance system. More particularly, the presently disclosed embodiments are related to methods and systems for ranking questions for a job interview.

### BACKGROUND

Rapid globalization and advancements in various fields, such as information technology, have witnessed an increased demand of skilled employees in the global market. Consequently, organizations are aiming for targeted hiring of candidates with specialized skills and relevant expertise. Generally, the organizations shortlist a required number of candidates from the ones who have applied for a job opening, based on a series written tests, followed by multiple rounds of interviews. Though, questions in the written test are usually the same for all the candidates, interview questions usually differ based on the job-description and profiles of the shortlisted candidates.

Typically, prior to such interviews, interviewers have to work through the job profile and the candidate profiles to prepare a set of customized questions for each of the candidates. Such a set of customized questions then facilitate the interviewer to test the skills and the expertise of the candidates in an optimal manner. Thus, the candidates are aptly evaluated based on the set of customized questions, and subsequently best candidate(s) are selected for the job. However, the preparation of the set of customized questions is a very tedious tasks for the interviewers due to significant man-hours required for the same. Thus, a simplified, efficient, and automated system may be desirable to overcome such problems faced by the interviewers.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for ranking a plurality of questions for a job interview. The method includes extracting, by one or more processors, the plurality of questions from a repository of questions, stored in a database server, based on at least a preference for the plurality of questions received from an interviewer-computing device. The method includes determining, by the one or more processors, a first score for a question from the plurality of questions, based on one or more of: one or more first metadata associated with a job-profile, and one or more second metadata associated with a candidate-profile. The method further includes determining, by the one or more processors, a second score for the question from the plurality of questions, based on a count of correct responses and a count of incorrect responses to the question associated with one or more previous interviews. The method further includes determining, by the one or more processors, a third score for the question from the plurality of questions, based on at least a selection of the question from the plurality of questions by one or more interviewers in the one or more previous interviews. The method further includes ranking, by the one or more processors, the plurality of questions based on at least a weighted sum of the first score, the second score, and the third score associated with each of the plurality of questions. The method further includes presenting, by the one or more processors, a user interface on a display screen of an interviewer-computing device displaying the ranked plurality of questions, based on at least the preference of an interviewer for the plurality of questions.

According to embodiments illustrated herein, there is provided a job interview assistance system. The system includes one or more processors in a data processing unit, wherein the data processing unit is connected to a terminal device relating to a provider of data via a communication network, the one or more processors being configured to determine a first score for a question from a plurality of questions, based on one or more of: one or more first metadata associated with a job-profile, and one or more second metadata associated with a candidate-profile. The one or more processors are further configured to determine a second score for the question from the plurality of questions, based on a count of correct responses and a count of incorrect responses to the question associated with one or more previous interviews. The one or more processors are further configured to determine a third score for the question from the plurality of questions, based on at least a selection of the question from the plurality of questions by one or more interviewers in the one or more previous interviews. The one or more processors are further configured to rank the plurality of questions based on at least a weighted sum of the first score, the second score, and the third score associated with each of the plurality of questions. The one or more processors are further configured to present a user interface on a display screen of an interviewer-computing device displaying the ranked plurality of questions, based on at least a preference of an interviewer for the plurality of questions.

According to embodiments illustrated herein, there is provided a computer program product for use with a computing device. The computer program product comprises a non-transitory computer readable medium storing a computer program code for ranking a plurality of questions for a job interview. The computer program code is executable by one or more processors in the computing device to determine a first score for a question from a plurality of questions, based on one or more of: one or more first metadata associated with a job-profile, and one or more second metadata associated with a candidate-profile. The computer program code is further executable by the one or more processors to determine a second score for the question from the plurality of questions, based on a count of correct responses and a count of incorrect responses to the question associated with one or more previous interviews. The computer program code is further executable by the one or more processors to determine a third score for the question from the plurality of questions, based on at least a selection of the question from the plurality of questions by one or more interviewers in the one or more previous interviews. The computer program code is further executable by the one or more processors to rank the plurality of questions based on at least a weighted sum of the first score, the second score, and the third score associated with each of the plurality of questions. The computer program code is further executable by the one or more processors to present a user interface on a display screen of an interviewer-computing device displaying the ranked plurality of questions, based on at least a preference of an interviewer for the plurality of questions.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram that illustrates a system for ranking a plurality of questions for a job interview, in accordance with at least one embodiment;

FIG. 3 is a flowchart that illustrates a method for ranking a plurality of questions for a job interview, in accordance with at least one embodiment; and

FIGS. 4A-4H are block diagrams that illustrate exemplary graphical user interfaces for job interview assistance system, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a device that includes one or more processors/microcontrollers and/or any other electronic components, a device, or a system that performs one or more operations according to one or more programming instructions/codes. Examples of the computing device may include, but are not limited to, a desktop computer, a laptop, a personal digital assistant (PDA), a mobile device, a smartphone, and/or a tablet computer (e.g., iPad® and Samsung Galaxy Tab®).

An “organization” refers to an entity comprising a group of individuals engaged in a business of selling/providing products/services to one or more other organizations or individuals.

A “job interview” refers to an interview that may be considered as one of stages to determine whether a candidate is suitable for a position of employment in an organization.

A “question” refers to a sentence (associated with one or more subject matters) of inquiry that may be asked for a reply from an individual. For example, an interviewer may ask a question to an interviewee during a job interview. In an embodiment, the question may be based on at least a job opening, and/or one or more skills of the interviewee.

An “interviewer” refers to an individual who conducts an interview. For example, an interviewer may conduct an interview to determine whether a candidate, from one or more candidates who have applied for a job, is suitable for the job or not. During the process of the interview, the interviewer may ask one or more questions to the candidate. Based on at least responses to the one or more questions, the interviewer may take a decision about a selection of the candidate for a next stage of recruitment process. Hereinafter, “an interviewer,” “a human resource manager,” “a hiring manager,” “a project manager,” and/or the like, may be interchangeably used.

A “candidate” refers to an individual who has applied for a job opening in an organization. In an embodiment, the candidate may utilize a computing device to log on to a portal of the organization to apply for the job opening. Further, the candidate may upload his/her profile (e.g., a curriculum vitae) on the portal of the organization. Based on at least a selection of the candidate's profile for the job opening, the candidate may have to pass through one or more written tests and one or more interviews before being selected for the job opening. Hereinafter, “a candidate,” “an applicant,” “an interviewee,” “an answerer,” “a responder,” and/or the like, may be interchangeably used.

A “job-profile” refers to a profile that may define a nature of a job opening in an organization. In an embodiment, the job-profile may include a description of the job opening. Further, the description may reflect one or more of, but are not limited to, one or more required skills for the job opening, a domain of the job opening, one or more preferred areas of expertise, a designation associated with the job opening, a workplace culture, trainings, opportunities, advancements, a salary bracket (i.e., a minimum salary and a maximum salary), and other benefit packages associated with the job opening. Hereinafter, “a job-profile,” and “a job-description” may be interchangeably used.

A “candidate-profile” refers to a profile that may define one or more characteristics of a candidate. For example, a candidate-profile may include one or more of, but are not limited to, one or more technical skills, educational background, work experience, and soft skills of the candidate.

“One or more first metadata” refer to a set of data associated with a job-profile. In an embodiment, the one or more first metadata may be extracted from a description of the job-profile of a job opening in an organization. For example, the one or more first metadata may include one or more of, but are not limited to, a domain of the job opening, one or more required skills, a job title, a job role, and one or more required areas of study or expertise.

“One or more second metadata” refer to a set of data associated with a candidate-profile of a candidate. In an embodiment, the one or more second metadata may be extracted from the candidate-profile (e.g., a curriculum vitae) of the candidate, who may have applied for a job opening in an organization. For example, the one or more second metadata may include one or more of, but are not limited to, one or more areas of study of the candidate, one or more courses undertaken by the candidate, one or more skills developed by the candidate, and a historical job description of the candidate.

A “first score” refers to a numerical value that may be indicative of a relevance of a question with respect to a job-profile associated with a job opening, and/or a candidate-profile associated with a candidate who has applied for the job opening. In an embodiment, the first score may be determined based on one or more metadata associated with one or more of the job-profile and the candidate-profile.

A “second score” refers to a numerical value that may be indicative of at least a difficulty level associated with a question. In an embodiment, the second score may be determined based on at least a nature of responses (e.g., correct or incorrect) provided by one or more candidates for the question in one or more previous interviews. In another embodiment, the second score may be determined based on at least a feedback of one or more interviewers pertaining to the nature of responses provided by the one or more candidates for the question.

A “third score” refers to a numerical value that may be indicative of at least a trend of one or more questions that were asked by one or more interviewers in one or more previous interviews. In an embodiment, the third score may be determined to give a higher importance to each of the one or more questions that were selected by the one or more interviewers in the one or more previous interviews, and a lower importance to the one or more questions that were rarely asked by the one or more interviewers in the one or more previous interviews. The third score captures opinion of the one or more interviewers on what they consider are practically useful and significant question in the interview.

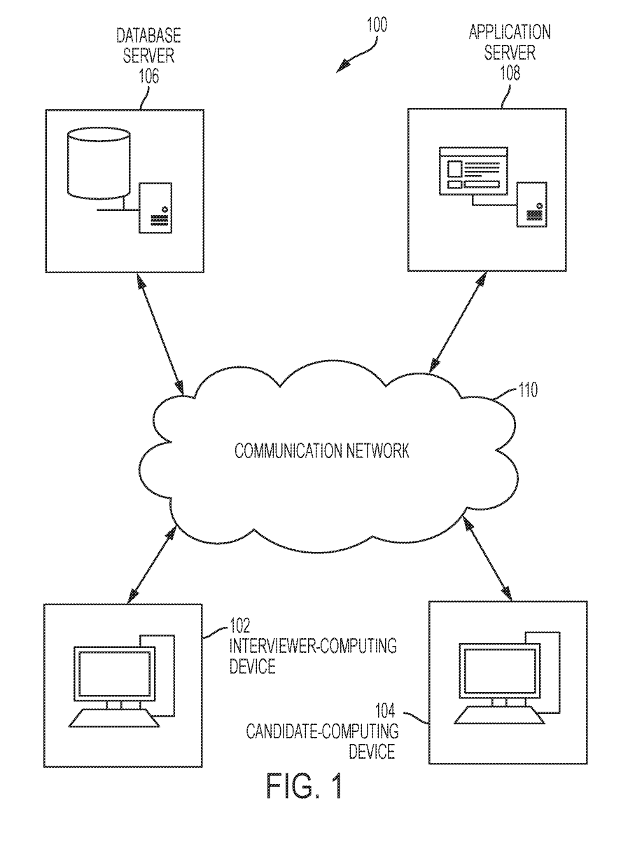

FIG. 1 is a block diagram of a system environment 100 in which various embodiments may be implemented. The system environment 100 includes an interviewer-computing device 102, a candidate-computing device 104, a database server 106, an application server 108, and a communication network 110. Various devices and servers in the system environment 100 may be interconnected over the communication network 108.

The interviewer-computing device 102 refers to a computing device that may be utilized by one or more individuals associated with an entity (e.g., an organization, or an institution) to perform one or more operations. The one or more individuals associated with the entity may correspond to one or more of: one or more interviewers, one or more hiring managers, one or more managers, one or more project managers, and/or the like.

Further, the interviewer-computing device 102 may comprise one or more processors and one or more memories. The one or more memories may include computer readable codes and instructions that may be executable by the one or more processors to perform the one or more operations. The one or more operations may include one or more of, but are not limited to, receiving one or more inputs from the one or more individuals, and transmitting and displaying content/messages in response to the one or more inputs. In an embodiment, the interviewer-computing device 102 may be configured to perform the one or more operations over the communication network 110.

In an embodiment, the interviewer-computing device 102 may be operable to perform the one or more operations based on one or more requests received from the one or more individuals. For example, the one or more individuals may utilize one or more input devices (e.g., a keyboard, a mouse, a touchpad, etc.) associated with one or more computing devices, such as the interviewer-computing device 102, to provide the one or more inputs. For example, the one or more individuals, such as a hiring manager, may utilize a computing device, such as a hiring manager-computing device (not shown) to create one or more job openings. The hiring manager may create the one or more job openings based on at least a shortage of skilled employees in the organization or a requirement of new skilled employees in the organization. Further, the hiring manager may utilize the computing device to view profiles of one or more candidates who may have applied for the one or more job openings. Further, the hiring manager may notify the one or more candidates about one or more written tests and one or more interviews. Based on a performance of the one or more candidates in the one or more written tests, the hiring manager may select one or more first candidates from the one or more candidates for the one or more interviews. Further, the hiring manager may utilize the computing device to notify the one or more interviewers and each of the one or more first candidates about the one or more interviews.

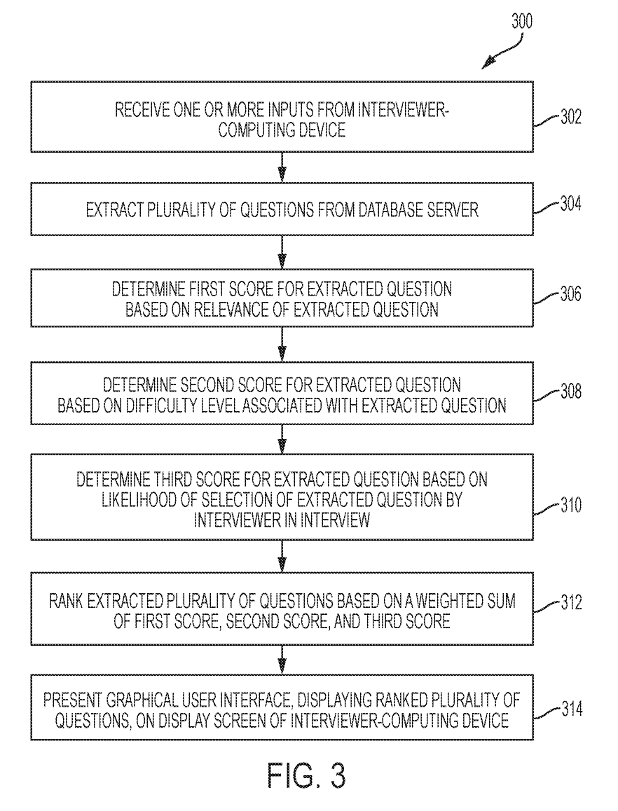

Further, an interviewer, from the one or more interviewers, may utilize the computing device, such as the interviewer-computing device 102, to view details of the one or more interviews. For example, the details of the one or more interviews may include one or more of, but are not limited to, a time slot, a candidate-profile, and an interview location. Further, the interviewer may select a job-profile, from one or more job-profiles, based on at least the time slot of the one or more interviews. Further, the interviewer may utilize the interviewer-computing device 102 to provide one or more preferences for filtering a plurality of questions from one or more questions. The one or more preferences of the interviewer may be based on the job-profile and/or a candidate-profile. The interviewer may further utilize the interviewer-computing device 102 to view a ranked plurality of questions on a display screen of the interviewer-computing device 102. The ranking of the plurality of questions has been explained later in detail in conjunction with FIG. 3.

Further, the interviewer may utilize one or more of the ranked plurality of questions to examine a skill level of the one or more first candidates during the one or more interviews. Further, based at least on one or more responses provided by the one or more first candidates during the one or more interviews, the interviewer may utilize the interviewer-computing device 102 to transmit feedback, for each of the one or more responses received from the one or more first candidates, to the database server 106 over the communication network 110.

The interviewer-computing device 102 may correspond to a variety of computing devices, such as, but not limited to, a laptop, a PDA, a tablet computer, a smartphone, and/or a phablet.

The candidate-computing device 104 refers to a computing device that may be utilized by a first candidate. The first candidate may correspond to an individual who may apply for the one or more job-profiles in the entity (e.g., the organization or the institution).

The candidate-computing device 104 may comprise one or more processors and one or more memories. The one or more memories may include computer readable codes and instructions that may be executable by the one or more processors to perform one or more operations. The one or more operations may include one or more of, but not limited to, receiving one or more inputs pertaining to the one or more job-profiles from the first candidate, transmitting the one or more inputs to the entity, and displaying content/messages in response to the one or more inputs. In an embodiment, the candidate-computing device 104 may be configured to perform the one or more operations over the communication network 110.

In an embodiment, the candidate-computing device 104 may be operable to perform the one or more operations based on one or more requests received from the first candidate. The first candidate may utilize the candidate-computing device 104 to perform one or more of, but not limited to, viewing one or more job openings of the organization, applying for the one or more job openings, and uploading his/her candidate-profile for the one or more job openings, via the communication network 110. Further, the first candidate may utilize the candidate-computing device 104 to transmit one or more queries to the organization to enquire about a status of the application for the one or more job openings. Further, the first candidate may utilize the candidate-computing device 104 to take one or more online tests pertaining to the one or more job openings over the communication network 110. Further, in an embodiment, the first candidate may utilize the candidate-computing device 104 to respond to an interview question during an online interview (e.g., interview over Skype).

The candidate-computing device 104 may correspond to a variety of computing devices such as, but not limited to, a laptop, a PDA, a tablet computer, a smartphone, and/or a phablet.

The database server 106 may refer to a computing device or a storage device that may be configured to store a repository of questions, in accordance with at least one embodiment. The repository of questions may include the one or more questions associated with one or more skills and/or one or more technical areas, such as machine learning, data mining, Java, C++, Oracle, energy system, VLSI, and/or like. Further, each of the one or more questions are associated with one or more areas of study, such as Computer Science, Electronics, Telecommunication, and/or the like. In an embodiment, the application server 108 may be configured to determine the one or more skills, one or more technical areas, and one or more areas of study of the one or more questions by use of one or more natural processing techniques, known in the art. Further, the database server 106 may be configured to store one or more responses, pertaining to the one or more questions, provided by one or more second candidates in one or more previous interviews. The database server 106 may further be configured to store feedback, pertaining to each of the one or more responses, provided by the one or more interviewers. The database server 106 may have received the one or more responses and the corresponding feedback from the one or more computing-devices, such as the interviewer-computing device 102, over the communication network 110.

Further, in an embodiment, the database server 106 may be configured to store the candidate-profile (i.e., curriculum vitae) of each of the one or more second candidates who may have applied for the one or more job openings in the past. The database server 106 may further store the candidate-profile of the one or more first candidates who may have applied for one or more current job openings in the organization. The candidate-profile may comprise personal data, such as name, gender, age, relationship status, educational background, and/or the like, and professional data, such as previous work history, salary, skills, projects, and/or the like.

In an embodiment, the database server 106 may be communicatively coupled over the communication network 110. In an embodiment, the database server 106 may be configured to transmit or receive one or more queries, the one or more inputs (from the one or more interviewers or the one or more first candidates), content (e.g., responses, feedbacks, candidate-profiles, etc.) to/from one or more computing devices, such as the interviewer-computing device 102, the candidate-computing device 104, and the application server 108 over the communication network 110. Further, in an embodiment, the database server 106 may store one or more instructions, codes, scripts, or programs that may be retrieved by the application server 108 to perform one or more operations for ranking the plurality of questions for the one or more interviews. For querying the database server 106, one or more querying languages may be utilized, such as, but not limited to, SQL, QUEL, and DMX. Further, the database server 106 may be realized through various technologies such as, but not limited to, Microsoft® SQL server, Oracle, and My SQL.

The application server 108 may refer to a computing device or a software framework that may provide a generalized approach to create the application-server implementation. In an embodiment, the functionalities of the application server 108 may be dedicated to the efficient execution of procedures such as, but not limited to, programs, routines, or scripts stored in one or more memories for supporting its applied applications.

In an embodiment, the application server 108 may be configured to rank the plurality of questions. Prior to the ranking of the plurality of questions, the application server 108 may receive the one or more inputs from the interviewer-computing device 102 over the communication network 110. The one or more inputs may be indicative of at least the selection of the job-profile by the interviewer for an interview, and the one or more preferences of the interviewer for the plurality of questions for the interview. Based on the one or more inputs received from the interviewer, the application server 108 may be configured to transmit a query to the database server 106 to extract the plurality of questions from the repository of questions. The extraction of the plurality of questions has been explained later in detail in conjunction with FIG. 3.

After extracting the plurality of questions, the application server 108 may be configured to determine a first score, a second score, and a third score for each of the plurality of questions. In an embodiment, the application server 108 may determine the first score based on at least one or more metadata associated with each of the job-profile and/or the candidate-profile. In an embodiment, the application server 108 may determine the second score based on at least correctness of the one or more responses provided by the one or more candidates in the one or more previous interviews. In an embodiment, the application server 108 may determine the third score based on at least a trend of the one or more questions that had been asked by the one or more interviewers in the one or more previous interviews. The determination of the first score, the second score, and the third score have been explained later in detail in conjunction with FIG. 3.

Further, in an embodiment, the application server 108 may be configured to determine a weighted sum of the first score, the second score, and the third score for each of the extracted plurality of questions. Based on at least the weighted sum of each of the extracted plurality of questions, the application server 108 may rank the extracted plurality of questions. Thereafter, the application server 108 may present a graphical user interface (GUI) on the display screen of the interviewer-computing device 102 over the communication network 110. The GUI may be configured to display the ranked plurality of questions to the interviewer. The interviewer may utilize one or more of the ranked plurality of questions to examine the skill level of the first candidate during the interview.

Further, in an embodiment, the application server 108 may receive the one or more responses and the feedback, pertaining to each of the one or more of the ranked plurality of questions, from the interviewer-computing device 102 over the communication network 110. The application server 108 may store the one or more responses and the corresponding feedback into the database server 106.

The application server 108 may be realized through various types of application servers such as, but are not limited to, Java application server, .NET framework application server, and Base4 application server.

A person having ordinary skills in the art will understand that the scope of the disclosure is not limited to the database server 106 and the application server 108 as separate entities. In an embodiment, the database server 106 may be integrated into the application server 108, or vice-versa. In such one scenario, the application server 108 may be configured to perform the functionalities of the database server 106.

A person having ordinary skills in the art will understand that the scope of the disclosure is not limited to the interviewer-computing device 102 and the application server 108 as separate entities. In an embodiment, the application server 108 may be integrated into the interviewer-computing device 102, or vice-versa. In such one scenario, the interviewer-computing device 102 may be configured to perform the functionalities of the application server 108.

The communication network 110 corresponds to a medium through which content, messages, and queries flow between various devices of the system environment 100 (e.g., the interviewer-computing device 102, the candidate-computing device 104, the database server 106, and the application server 108). Examples of the communication network 110 may include, but are not limited to, a Long Term Evolution (LTE) network, a Wireless Fidelity (Wi-Fi) network, a Wireless Area Network (WAN), a Local Area Network (LAN), or a Metropolitan Area Network (MAN). Various devices in the system environment 100 can connect to the communication network 110 in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, and/or cellular communication protocols (such as 2G, 3G, or 4G communication protocols).

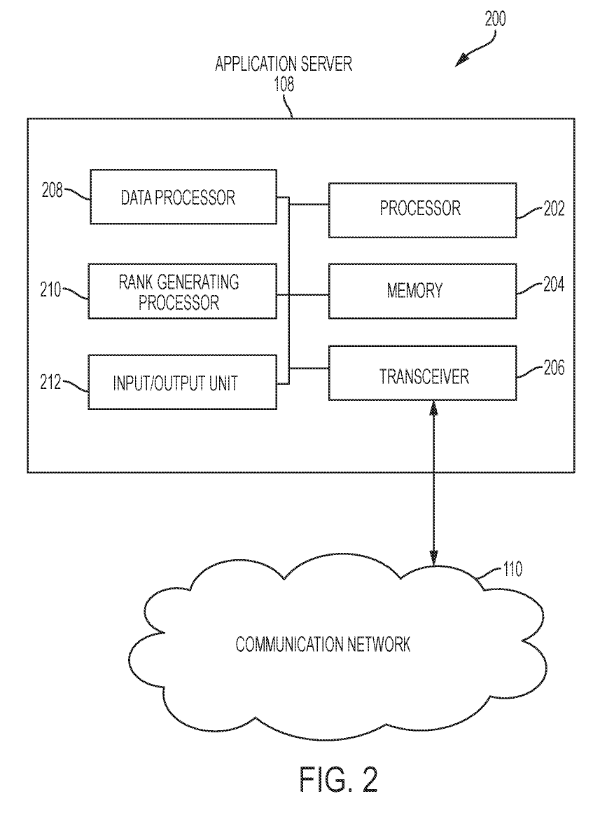

FIG. 2 is a block diagram that illustrates a system 200 for ranking the extracted plurality of questions for the job interview, in accordance with at least one embodiment. In an embodiment, the system 200 may correspond to the interviewer-computing device 102, the candidate-computing device 104, and the application server 108. For the purpose of ongoing description, the system 200 is considered as the application server 108. However, the scope of the disclosure should not be limited to the system 200 as the application server 108. The system 200 may also be realized as the interviewer-computing device 102, or the candidate-computing device 104, without departing from the spirit of the disclosure.

The application server 108 may include one or more processors, such as a processor 202, one or more memories, such as a memory 204, one or more transceivers, such as a transceiver 206, one or more data processors, such as a data processor 208, one or more rank generating processors, such as a rank generating processor 210, and one or more Input/Output Units, such as an Input/Output unit 212. The transceiver 206 is connected to the communication network 110.

The processor 202 comprises suitable logic, circuitry, interfaces, and/or code that may be configured to execute one or more sets of instructions, codes, scripts, and programs stored in the memory 204. The processor 202 is coupled to the memory 204, the transceiver 206, the data processor 208, the rank generating processor 210, and the Input/Output unit 212. The processor 202 may execute the one or more sets of instructions, codes, scripts, and programs stored in the memory 204 to perform one or more associated operations (e.g., receiving one or more inputs, processing requests associated with the one or more inputs, transmitting responses pertaining to the requests, and/or the like). The processor 202 may be implemented based on a number of processor technologies, known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202, the data processor 208, and the rank generating processor 210. The memory 204 may store the one or more sets of instructions, codes, scripts, and programs. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202, the data processor 208, and/or the rank generating processor 210 to perform one or more associated operations. It will be apparent to a person having ordinary skill in the art that the one or more sets of instructions, codes, scripts, and programs stored in the memory 204 may enable the hardware of the system 200 to perform the one or more associated operations.

The transceiver 206 may be operable to communicate with the one or more devices, such as the interviewer-computing device 102, the candidate-computing device 104, and/or one or more servers, such as the database server 106 over the communication network 110. The transceiver 206 may be configured to receive the one or more inputs from the interviewer-computing device 102 over the communication network 110. Further, the transceiver 206 may be configured to store information pertaining to the one or more inputs in the memory 204. The transceiver 206 may further transmit the responses pertaining to the requests in the one or more inputs to the interviewer-computing device 102 and the candidate-computing device 104. Examples of the transceiver 206 may include, but are not limited to, an antenna, an Ethernet port, a USB port, or any other port that can be configured to receive and transmit data. The transceiver 206 receives and transmits the one or more inputs, queries, responses, information, content or messages in accordance with the various communication protocols, such as, TCP/IP, UDP, and 2G, 3G, or 4G communication protocols through an input terminal and an output terminal, respectively over the communication network 110.

The data processor 208 may comprise suitable logic, circuitry, interfaces, and/or code that may be operable to execute one or more sets of instructions, codes, scripts, and programs stored in the memory 204. The data processor 208 may further be realized by use of one or more mathematical models, one or more statistical models, and/or one or more algorithms. Further, the data processor 208 may include one or more functionalities of one or more tools, known in the art, such as a CV parsing tool, a POS tagger tool, and/or the like. The data processor 208 may utilize the one or more functionalities of each of the CV parsing tool and the POS tagger tool to extract the one or more skills and the one or more technical areas from the candidate-profile (i.e., a curriculum vitae) of the first candidate. The data processor 208 may further extract one or more of, but not limited to, one or more areas of study of the first candidate, one or more course undertaken by the first candidate, and a historical job description of the first candidate, from the curriculum vitae of the first candidate.

Further, in an embodiment, the data processor 208 may utilize one or more query expansion techniques known in the art, to extract the one or more technical areas from the one or more questions in the repository of questions. Further, the data processor 208 may utilize a knowledge database, to determine the one or more skills that may be tested by each of the one or more questions.

Further, in an embodiment, the data processor 208 may be configured to extract one or more required skills (mandatory and desired), one or more required areas of study, and one or more technical areas for the job-profile from a description of the job-profile.

Though, the data processor 208 is depicted as independent from the processor 202 in FIG. 2, a person skilled in the art will appreciate that the data processor 208 may be implemented within the processor 202 without departing from the scope of the disclosure. Further, a person skilled in the art will appreciate that the processor 202 may be configured to perform the functionalities of the data processor 208 without departing from the scope of the disclosure. The data processor 208 may be implemented based on a number of processor technologies known in the art. Examples of the data processor 208 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The rank generating processor 210 may comprise suitable logic, circuitry, interfaces, and/or code that may be operable to execute one or more sets of instructions, codes, scripts, and programs stored in the memory 204. The ranking generating processor 210 may further be realized by use of one or more mathematical models, one or more statistical models, and/or one or more algorithms. In an embodiment, the rank generating processor 210 may be configured to rank the extracted plurality of questions. The rank generating processor 210 may rank the extracted plurality of questions based on at least the one or more preferences of the interviewer. Though, the rank generating processor 210 is depicted as independent from the processor 202 in FIG. 2, a person skilled in the art will appreciate that the rank generating processor 210 may be implemented within the processor 202 without departing from the scope of the disclosure. Further, a person skilled in the art will appreciate that the processor 202 may be configured to perform the functionalities of the rank generating processor 210 without departing from the scope of the disclosure. The rank generating processor 210 may be implemented based on a number of processor technologies known in the art. Examples of the rank generating processor 210 may include, but are not limited to, an X86-based processor, a Reduced Instruction Set Computing (RISC) processor, an Application-Specific Integrated Circuit (ASIC) processor, and/or a Complex Instruction Set Computing (CISC) processor.

The Input/Output unit 212 may comprise suitable logic, circuitry, interfaces, and/or code that may be operable to receive the one or more inputs or queries from the one or more interviewers. Further, the Input/Output unit 212 may be configured to transmit the one or more responses pertaining to the one or more inputs or queries to the interviewer-computing device 102, the candidate-computing device 104, and/or the database server 106. The Input/Output unit 212 may be operable to communicate with the processor 202, the memory 204, the transceiver 206, the data processor 208, and the rank generating processor 210. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The operation of the application server 108 has been explained in detail in conjunction with FIG. 3.

FIG. 3 is a flowchart 300 that illustrates a method for ranking the plurality of questions for the job interview, in accordance with at least one embodiment. The flowchart 300 has been described in conjunction with FIG. 1 and FIG. 2.

At step 302, the one or more inputs are received from the interviewer-computing device 102. The interviewer may utilize the interviewer-computing device 102 to transmit the one or more inputs. In an embodiment, the processor 202 may be configured to receive the one or more inputs from the interviewer-computing device 102 over the communication network 110. Further, the processor 202 may store the one or more inputs into the memory 204.

Prior to receiving the one or more inputs, the processor 202 may be configured to transmit a notification message (e.g., a mail or an SMS) to the interviewer. The notification message may include information associated with the one or more interviews that may have been allocated to the interviewer. Based on at least the notification message, the interviewer may utilize the interviewer-computing device 102 to log onto a portal (e.g., a job interview assistance portal) of the organization to view the details of the one or more allocated interviews. After logging onto the portal, the processor 202 may present a graphical user interface (GUI) on the display screen of the interviewer-computing device 102 over the communication network 110. The GUI may be configured to display a list of the one or more interviews that have been allocated to the interviewer. The interviewer may further view the information associated with the one or more allocated interviews. For example, the information may include one or more job-profiles, and corresponding job IDs, job titles, and one or more required skills (mandatory and desired). The information may further include a time slot of each of the one or more allocated interviews, one or more candidate-profiles associated with each of the one or more allocated interviews, an interview location, and/or the like.

Thereafter, the interviewer may utilize the interviewer-computing device 102 to provide a first input. The first input may be indicative of at least a selection of an allocated interview from the list of the one or more allocated interviews. After receiving the first input, the processor 202 may present a graphical user interface (GUI) on the display screen of the interviewer-computing device 102. The GUI may be configured to display the job-profile associated with the allocated interview. Further, in an embodiment, the GUI may be configured to display one or more requirements (skill-wise, qualification-wise, and/or the like) of the job-profile, and the one or more technical areas associated with the job-profile. In an embodiment, the GUI may further be configured to display the one or more candidate-profiles of the one or more candidates associated with the allocated interview.

Further, in an embodiment, the interviewer may utilize the interviewer-computing device 102 to provide a second input. The second input may be indicative of at least the one or more preferences of the interviewer for the plurality of questions. In an embodiment, the one or more preferences of the interviewer for the plurality of questions may be based on at least one of the job-profile or the candidate-profile associated with the allocated interview.

After receiving the second input, the processor 202 may be configured to extract the plurality of questions from the database server 106. The extraction of the plurality of questions has been explained in conjunction with step 304.

At step 304, the plurality of questions are extracted from the database server 106. In an embodiment, the processor 202 may be configured to extract the plurality of questions from the database server 106 based on at least the second input. As discussed in step 302, the second input is indicative of the one or more preferences of the interviewer for the plurality of questions. For example, the interviewer may prefer to view the plurality of questions based on the job-profile associated with the allocated interview. In another exemplary scenario, the interviewer may prefer to view the plurality of questions based on the candidate-profile associated with the allocated interview. In another exemplary scenario, the interviewer may prefer to view the plurality of questions based on the job-profile and the candidate-profile associated with the allocated interview.

Further, in an embodiment, the processor 202 may be configured to extract the plurality of questions from the database server 106 based on the one or more preferences provided by the interviewer. In an embodiment, the processor 202 may be configured to extract the plurality of questions from the database server 106 based on the one or more technical areas, the one or more skills, and the one or more areas of study associated with the one or more preferences of the interviewer.

Prior to extracting the plurality of questions from the database server 106, the data processor 208 may be configured to extract the one or more technical areas from at least one of the job-profile or the candidate-profile associated with the allocated interview. The data processor 208 may utilize the one or more tools (e.g., the POS tagger tool, the CV parsing tool, and/or the like), known in the art, to extract the one or more technical areas (and/or the one or more skills, and/or the one or more areas of study) from at least one of the job-profile or the candidate-profile. The extraction of the one or more technical areas may depend upon the second input received from the interviewer-computing device 102 over the communication network 110. For example, the data processor 208 may be configured to extract the one or more technical areas from the description of the job-profile when the interviewer has preferred the job-profile over the candidate-profile for the plurality of questions. In another exemplary scenario, the data processor 208 may be configured to extract the one or more technical areas from the candidate-profile when the interviewer has preferred the candidate-profile over the job-profile for the plurality of questions. In a scenario where the interviewer has preferred the job-profile as well as the candidate-profile for the plurality of questions, the data processor 208 may be configured to extract the one or more technical areas from the description of the job-profile and the candidate-profile.

After extracting the one or more technical areas based on the second input, the processor 202 may be configured to compare the one or more extracted technical areas with the one or more technical areas of the one or more questions in the repository of questions stored in the database server 106. Based on at least the comparison, the processor 202 may extract the plurality of questions from the repository of questions stored in the database server 106. In an embodiment, the processor 202 may extract a question from the repository of questions when each of the one or more technical areas associated with the question is required for the job-profile. For example, a hiring manager wishes to determine a set of questions for an interview, such that selection of the set of questions is based on a job-profile (e.g., a Data Scientist) associated with the interview. In such a case, the data processor 208 may be configured to extract one or more first technical areas from a description of the job-profile. For illustrative purpose, the one or more first technical areas of the job-profile (i.e., the Data Scientist) are shown in Table 1.

TABLE 1

| Job-Profile | One or more first technical areas |
|---|---|
| Data Scientist | Algorithms, Big Data, Data Mining, |
| | Machine Learning, NLP, Text Mining |

For simplicity, consider a repository of questions, stored in the database server 106, comprising six questions. Each of the six questions are associated with one or more second technical areas. For illustrative purpose, the one or more second technical areas of each of the six questions are shown in Table 2.

TABLE 2

| Repository of Questions | One or more second technical areas |
|---|---|
| Question-1 | Data Mining, Big Data, Algorithms, |
| | Machine Learning |
| Question-2 | Machine Learning, Clustering |
| Question-3 | Distributed Computing |
| Question-4 | Power System, Energy System, |
| | Renewable Energy |
| Question-5 | NLP, Text Mining, Algorithms |
| Question-6 | Data Mining, Text Mining, Big Data |

Thereafter, the processor 202 may compare the one or more first technical areas associated with the job-profile (i.e., the Data Scientist) as shown in Table 1 with the one or more second technical areas associated with each of the six questions as shown in Table 2. In an embodiment, the processor 202 may be configured to select a question from the repository of questions if each of the one or more second technical areas associated with the question is a subset of the one or more first technical areas associated with the job-profile. In such a case, the processor 202 may select “Question-1”, “Question-2”, “Question-5”, and “Question-6”. Therefore, with respect to the ongoing exemplary scenario, the plurality of questions includes four questions (i.e., “Question-1”, “Question-2”, “Question-5”, and “Question-6”).

A person having ordinary skills in the art will understand that the scope of the disclosure is not limited to the extraction of the plurality of questions as discussed above. In an embodiment, the processor 202 may be configured to extract the question from the repository of questions if at least one of the one or more technical areas associated with the question is part of the one or more extracted technical areas associated with the job-profile.

Prior to the ranking of the extracted plurality of questions, the processor 202 may be configured to determine the first score, the second score, and the third score for each of the extracted plurality of questions. For simplicity, steps 306,308, and 310 explain the determination of the first score, the second score, and the third score for an extracted question in the extracted plurality of questions. The processor 202 may utilize the same procedure to determine the first score, the second score, and the third score for each of the remaining extracted plurality of questions.

At step 306, the first score is determined for the extracted question. The first score of the extracted question may be indicative of a relevance of the extracted question with respect to the job-profile and/or the candidate-profile. In an embodiment, the processor 202 may be configured to determine the first score for the extracted question. In an embodiment, the processor 202 may determine the first score of the extracted question based on at least one or more first metadata associated with the job-profile and/or one or more second metadata associated with the candidate-profile. The one or more first metadata associated with the job-profile may include one or more of, but not limited to, the one or more mandatory skills required for the job-profile, the one or more desired skills required for the job-profile, the one or more areas of study required for the job-profile, the job title, and the job role. The one or more second metadata associated with the candidate-profile of the first candidate may include one or more of, but not limited to, the one or more areas of study of the first candidate, the one or more courses undertaken by the first candidate, the historical job description of the first candidate, the one or more skills mentioned by the first candidate in the candidate-profile, and the one or more skills or technical areas associated with one or more projects worked upon by the first candidate in the past.

Determination of the first score of the extracted question with respect to the Job-Profile (first score_{j-profile})

In an embodiment, the first score of the extracted question with respect to the job-profile may correspond to a weighted sum of one or more job scores. In an embodiment, a job score is a numerical value pertaining to a corresponding first metadata in the one or more first metadata associated with the job-profile.

Prior to the determination of the first score, the processor 202 may be configured to determine the one or more job scores. Hereinafter, the job score, pertaining to the one or more skills (mandatory and desired) required for the job-profile, has been referred to as scoreⱼ_{_}ₛₖᵢₗₗ. Further, the job score, pertaining to the job title and the job role of the job-profile, has been referred to as score_{job}. Further, the job score, pertaining to the one or more areas of study required for the job-profile, has been referred to as scoreⱼ_{_}_{area of study}.

In an embodiment, the processor 202 may be configured to determine the job score (scoreⱼ_{_}ₛₖᵢₗₗ) for the extracted question. To determine the job score (scoreⱼ_{_}ₛₖᵢₗₗ) for the extracted question, the processor 202 may determine a count of skills associated with the job-profile that may be tested by the extracted question. The count of skills may be determined based on at least a comparison of the one or more skills associated with the extracted question with the one or more skills required by the job-profile. In exemplary scenario, the processor 202 may utilize following relation (denoted by equation-1) to determine a job score (scoreⱼ_{_}ₛₖᵢₗₗ) for an extracted question.

$$\begin{matrix}{score}_{j\_skill} = ( {w}_{manadatory} * {skill}_{manadatory} ) + ( {w}_{desired} * {skill}_{desired} ) & ( 1 ) \\ {skill}_{manadatory} = \frac{{Q}_{manadatory}}{{N}_{manadatory}} & ( 2 ) \\ {skill}_{desired} = \frac{{Q}_{desired}}{{N}_{desired}} & ( 3 )\end{matrix}$$

where,

Q_{manadatory}: corresponds to a count of mandatory skills tested by the extracted question;

Q_{desired}: corresponds to a count of desired skills tested by the extracted question;

N_{manadatory}: corresponds to the count of the mandatory skills required for the job-profile;

N_{desired}: corresponds to the count of the desired skills required for the job-profile;

w_{manadatory}: corresponds to a user (e.g., the interviewer) defined value for scoring mandatory skills in a range (0,1), default is 0.7; and

w_{desired}: corresponds to user (e.g., the interviewer) defined value for scoring desired skills in a range (0,1), default is 0.3.

Further, in an embodiment, the processor 202 may be configured to determine the job score (score_{job}) for the extracted question. The processor 202 may determine the job score (score_{job}) for the extracted question based on at least a measure of similarity of the extracted question with the job title and the job role. In an embodiment, the processor 202 may utilize one or more similarity measure techniques that are known in natural language processing to determine the similarity measure of the extracted question.

Further, in an embodiment, the processor 202 may be configured to determine the job score (scoreⱼ_{_}_{area of study}) for the extracted question. The processor 202 may determine the job score (score_{j area of study}) for the extracted question based on at least a comparison of the one or more areas of study associated with the extracted question with the one or more areas of study required by the job-profile.

After the determination of the one or more job scores pertaining to the one or more first metadata associated with the job-profile, the processor 202 may determine the first score of the extracted question with respect to the job-profile (first score_{j-profile}). The first score with respect to the job-profile (first score_{j-profile}) is a weighted sum of the one or more job scores (i.e., scoreⱼ_{_}ₛₖᵢₗₗ, score_{job}, and scoreⱼ_{_}_{area of study}). In an exemplary scenario, the processor 202 may utilize following relation (denoted by equation-4) to determine the first score of the extracted question with respect to the job-profile (first score_{f-profile}).

first score_{j-profile}=(wⱼ_{ₛₖᵢₗₗ}*scoreⱼ_{ₛₖᵢₗₗ})+(w_{job}*score_{job})+(wⱼ_{_}_{area of study}*scoreⱼ_{_}_{area of study}) (4)

wherein,

wⱼ_{_}ₛₖᵢₗₗ, w_{job}, and wⱼ_{_}_{area of study}: correspond to a user (e.g., the interviewer) defined values in the range (0,1). In case the user has not defined, the processor 202 may assign a random value from the range (0,1) that is same for each of the weights (i.e., wⱼ_{_}ₛₖᵢₗₗ, w_{job} and wⱼ_{_}_{area of study}).

Determination of the First Score of the Extracted Question with Respect to the Candidate-Profile (First Score_{c-profile})

In an embodiment, the first score of the extracted question with respect to the candidate-profile may correspond to a weighted sum of one or more candidate scores. In an embodiment, a candidate score is a numerical value pertaining to a corresponding second metadata in the one or more second metadata associated with the candidate-profile.

Prior to the determination of the first score, the processor 202 may be configured to determine the one or more candidate scores. Hereinafter, the candidate score, pertaining to the one or more areas of study of the first candidate, has been referred to as score_{c}_{_}_{area of study}. Further, the candidate score, pertaining to the one or more courses undertaken by the first candidate, has been referred to as score_{courses}. Further, the candidate score, pertaining to the historical job description of the first candidate, has been referred to as score_{historical job}. Further, the candidate score, pertaining to the one or more skills or technical areas associated with one or more projects worked upon by the first candidate in the past, has been referred to as score_{projects}. Further, the candidate score, pertaining to the one or more skills mentioned by the first candidate in the candidate-profile, has been referred to as score_{c}_{_}ₛₖᵢₗₗₛ.

In an embodiment, the processor 202 may be configured to determine the candidate score (score_{c}_{_}_{area of study}) for the extracted question. The processor 202 may determine the candidate score (score_{c}_{_}_{area of study}) for the extracted question based on at least a comparison of the one or more areas of study associated with the extracted question with the one or more areas of study of the candidate. In an embodiment, the candidate score (score_{c}_{_}_{area of study}) may correspond to a Boolean score. For example, score_{c}_{_}_{area of study}=1, if the extracted question belongs to at least one area of study of the candidate; and score_{c}_{_}_{area of study}=0, if the extracted question belongs to none of the areas of study of the candidate.

Further, in an embodiment, the processor 202 may be configured to determine the candidate score (score_{courses}) for the extracted question. The processor 202 may perform a check to determine if the extracted question belongs to at least one of the one or more courses undertaken by the first candidate. In case the extracted question belongs to at least one of the one or more courses undertaken by the first candidate, the processor 202 may determine the candidate score as, score_{courses}=1. However, in case the extracted question does not belong to at least one of the one or more courses undertaken by the candidate, the processor 202 may determine the candidate score as, score_{courses}=0.

Further, in an embodiment, the processor 202 may be configured to determine the candidate score (score_{historical job}) for the extracted question. The processor 202 may determine the candidate score (score_{historical job}) for the extracted question based on at least a measure of similarity of the extracted question with the historical job description of the first candidate. In an embodiment, the processor 202 may perform a check to determine the similarity of the extracted question with the historical job description of the first candidate by use of one or more similarity measure techniques that are known in natural language processing.

Further, in an embodiment, the processor 202 may be configured to determine the candidate score (score_{projects}) for the extracted question. The processor 202 may determine the candidate score (score_{projects}) for the extracted question based on at least a comparison of the one or more skills/technical areas associated with the question with the one or more skills/technical areas associated with one or more projects worked upon by the first candidate in the past. In an embodiment, the processor 202 may perform a check to determine if the extracted question covers at least one of the one or more skills/technical areas associated with one or more projects worked upon by the first candidate in the past. In case the extracted question covers at least one of the one or more skills/technical areas, the processor 202 may determine the candidate score as, score_{projects}=1. However, in case the extracted question does not cover at least one of the one or more skills/technical areas, the processor 202 may determine the candidate score as, score_{projects}=0.

Further, in an embodiment, the processor 202 may be configured to determine the candidate score (score_{c}_{_}ₛₖᵢₗₗ) for the extracted question. The processor 202 may determine the candidate score (score_{c}_{_}ₛₖᵢₗₗ) for the extracted question based on at least a comparison of the one or more skills associated with the extracted question with the one or more skills mentioned by the first candidate in the candidate-profile. In an embodiment, the processor 202 may perform a check to determine if the extracted question is associated with at least one of the one or more skills mentioned by the first candidate in the candidate-profile. In case the extracted question is associated with at least one of the one or more skills, the processor 202 may determine the candidate score as, score_{c}_{_}ₛₖᵢₗₗ=1. However, in case the extracted question is not associated with at least one of the one or more skills, the processor 202 may determine the candidate score as, score_{c}_{_}ₛₖᵢₗₗ=0.

After the determination of the one or more candidate scores pertaining to the one or more second metadata associated with the candidate-profile, the processor 202 may determine the first score of the extracted question with respect to the candidate-profile (first score_{c-profile}). The first score of the extracted question with respect to the candidate-profile (first score_{c-profile}) is a weighted sum of the one or more candidate scores (i.e., score_{c}_{_}_{area of study}, score_{courses}, score_{historical job}, score_{projects}, and score_{c}_{_}ₛₖᵢₗₗₛ). In an exemplary scenario, the processor 202 may utilize following relation (denoted by equation-5) to determine the first score of the extracted question with respect to the candidate-profile (first score_{c-profile}).

first score_{c-profile}=(w_{c}_{_{area of study}}*score_{c}_{_{area of study}})+(w_{courses}*score_{courses})+(w_{historicaljob}*score_{historical job})+(w_{projects}*score_{projects})+(w_{c}_{_}ₛₖᵢₗₗₛ*score_{c}_{_}ₛₖᵢₗₗₛ) (5)

wherein,

w_{c}_{_}_{area of study}, w_{courses}, w_{historicaljob}, w_{projects} and w_{c}_{_}ₛₖᵢₗₗₛ: correspond to user (e.g., the interviewer) defined values in the range (0,1). In case the user has not defined, the processor 202 may assign a random value from the range (0,1) that is same for each of the weights (i.e. w_{c}_{_}_{area of study}, w_{courses}, w_{historicaljob}, w_{projects} and w_{c}_{_}ₛₖᵢₗₗₛ).

After determining the first score of the extracted question with respect to the job-profile (first score_{j-profile}) and the first score of the extracted question with respect to the candidate-profile (first score_{c-profile}), the processor 202 may determine the first score of the extracted question with respect to the job-profile and the candidate-profile by use of following relation (denoted by equation-6).

first score=first score_{j-profile}+first score_{c-profile} (6)

Similarly, the processor 202 may determine the first score for each of the remaining extracted plurality of questions by use of one or more equations (denoted by equation-4, equation-5, and equation-6). In an embodiment, the selection of the one or more equations to determine the first score of each of the extracted plurality of questions is based on at least the one or more preferences of the interviewer depicted by the second input.

At step 308, the second score is determined for the extracted question. The second score of the extracted question may be indicative of a difficulty level associated with the extracted question. In an embodiment, the processor 202 may be configured to determine the second score for the extracted question. In an embodiment, the processor 202 may determine the second score of the extracted question, in the extracted plurality of questions, based on at least the one or more responses of the extracted question that had been provided by the one or more second candidates in the one or more previous interviews.

Prior to the determination of the second score, the processor 202 may be configured to extract the one or more responses, pertaining to the extracted question, from the database server 106. The processor 202 may further be configured to extract the feedback, pertaining to the one or more responses of the extracted question, from the database server 106. The feedback may have been provided by the one or more interviewers based on the one or more responses of the extracted question by the one or more second candidates. Thereafter, the data processor 208 may utilize one or more natural processing techniques known in the art to analyze the one or more responses and the feedback. The analysis may include at least a comparison of the one or more responses with one or more predefined responses. Based on at least the analysis, the data processor 208 may further determine the correctness of the one or more responses for the extracted question. Based on at least the correctness of the one or more responses for the extracted question, the data processor 208 may be configured to determine a count of correct responses to the extracted question, and a count of incorrect responses to the extracted question. In an exemplary scenario, the processor 202 may utilize following relation (equation-7) to determine a second score for an extracted question.

$$second score = \frac{{Count}_{incorrect responses}}{{Count}_{correct responses} + {Count}_{incorrect responses}} \qquad ( 7 )$$

wherein,

Count_{incorrect responses}: corresponds to a count of incorrect responses to an extracted question; and

Count_{correct responses}: corresponds to a count of correct responses to the extracted question.

Similarly, the processor 202 may determine the second score for each of the remaining extracted plurality of questions by use of the equation (denoted by equation-7).

At step 310, the third score is determined for the extracted question. The third score of the extracted question may be indicative of a likelihood of selection of the extracted question by the interviewer in the interview. In an embodiment, the processor 202 may be configured to determine the third score for the extracted question. In an embodiment, the processor 202 may determine the third score of the extracted question, in the extracted plurality of questions, based on at least a trend of the extracted question in the one or more previous interviews. In an embodiment, the trend of the extracted question may be determined based on a number of times the extracted question had been asked by the one or more interviewers in the one or more previous interviews. In an exemplary scenario, the processor 202 may utilize following relations (denoted by equation-8 and equation-9) to determine the third score.

Initially, the processor 202 may determine the third score of the extracted question by use of following relation (denoted by equation-8).

$$P ( q , 0 ) = \frac{1}{N} \qquad ( 8 )$$

wherein,

N: corresponds to a count of questions in the repository of questions.

Thereafter, the processor 202 may be configured to update the third score of the extracted question based on at least the number of times the extracted question had been asked by the one or more interviewers in the one or more previous interviews. The processor 202 may update the third score for the extracted question by use of following relation (denoted by equation-9).

$$\begin{matrix}{P}_{ques\_selection} ( k , i ) = {P}_{ques\_selection} ( k , i - 1 ) + \frac{α}{{N}_{selected\_ques}} , \\ if kth question is selected \\ = {P}_{ques\_selected} ( k , i - 1 ) , \\ if kth question is not selected\end{matrix} \qquad ( 9 )$$

wherein,

k=1 . . . N, where N is the count of questions in the repository of questions; N_{selected}_{_}_{ques}: corresponds to a count of questions in the extracted plurality of questions;

α: correspond to a predefined constant value in a range (0,1); and

P_{ques}_{_}_{selection}(k,i): corresponds to the third score for the kth question that has been selected for ith times in the one or more previous interviews.

Similarly, the processor 202 may determine the third score for each of the remaining extracted plurality of questions by use of the equations (denoted by equation-8 and equation-9). After determining the third score for each of the extracted plurality of questions, the processor 202 may be configured to normalize the third score, such that a sum of third scores of the extracted plurality of questions is “1.”

At step 312, the extracted plurality of questions are ranked. In an embodiment, the rank generating processor 210 may be configured to rank the extracted plurality of questions. In an embodiment, the rank generating processor 210 may be configured to rank the extracted plurality of questions based on at least a weighted sum of the first score, the second score, and the third score of each of the extracted plurality of questions.

Prior to the ranking of the extracted plurality of questions, the processor 202 may be configured to determine a fourth score for each of the extracted plurality of questions. The fourth score of the extracted question may correspond to the weighted sum of the first score, the second score, and the third score associated with the extracted question. In an exemplary scenario, the processor 202 may utilize following relation (denoted by equation-10) to determine a fourth score for an extracted question.

fourth score=(w_{relevance}*first score)+(w_{diffculty}*second score)+(w_{ques}_{_}_{selection}*third score) (10)

wherein,

w_{relevance}, w_{diffculty}, and w_{ques}_{_}_{selection}): correspond to user (e.g., preferences) defined values in the range (0,1). In case the user has not defined, the processor 202 may assign a random value from the range (0,1) that is same for each of the weights (i.e., w_{relevance}, w_{diffculty}, and w_{ques}_{_}_{selection}).

Similarly, the processor 202 may determine the fourth score for each of the remaining extracted plurality of questions by use of the equation (denoted by equation-10). After the determination of the fourth score for each of the extracted plurality of questions, the processor 202 may store the determined fourth score in the memory 204.

Further, in an embodiment, the rank generating processor 210 may be configured to rank each of the extracted plurality of questions based on at least the fourth score to obtain the ranked plurality of questions. For example, a first extracted question with a highest fourth score is ranked at top and a second extracted question with a lowest fourth score is ranked at bottom. After ranking the extracted plurality of questions, the rank generating processor 210 may store the ranked list of extracted questions into the memory 204.

At step 314, the GUI displaying the ranked plurality of questions, is presented on the display screen of the interviewer-computing device 102. In an embodiment, the processor 202 may be configured to present the GUI, displaying the ranked plurality of questions, on the display screen of the interviewer-computing device 102 over the communication network 110.

After receiving the ranked plurality of questions, the interviewer may select one or more of the ranked plurality of questions to test/check the skill level of the first candidate during the interview. Further, the interviewer may utilize the interviewer-computing device 102 to transmit the one or more responses, received from the first candidate for the one or more of the ranked plurality of questions, to the database server 106 or the memory 204. The interviewer may further transmit the feedback, pertaining to the one or more responses, to the database server 106 or the memory 204.

Thereafter, in an embodiment, the processor 202 may be configured to update the second score based on at least the selection of the one or more of the ranked plurality of questions during the interview. Further, in an embodiment, the processor 202 may be configured to update the third score based on at least the one or more responses and the one or more feedback received from the interviewer.

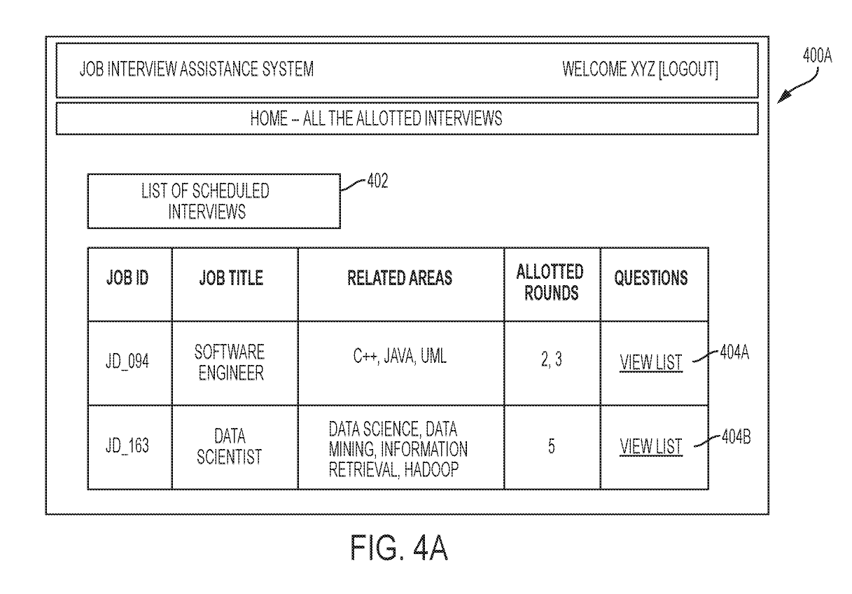

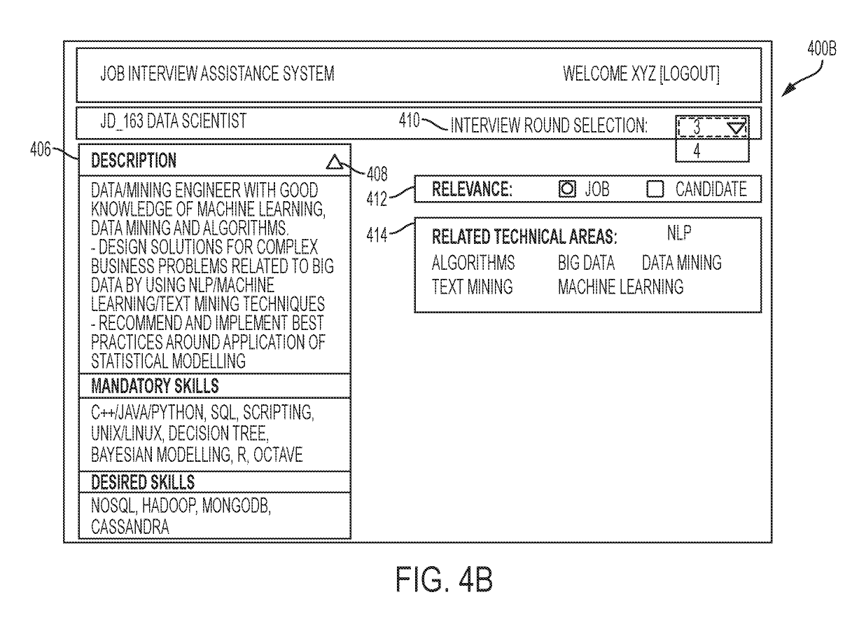

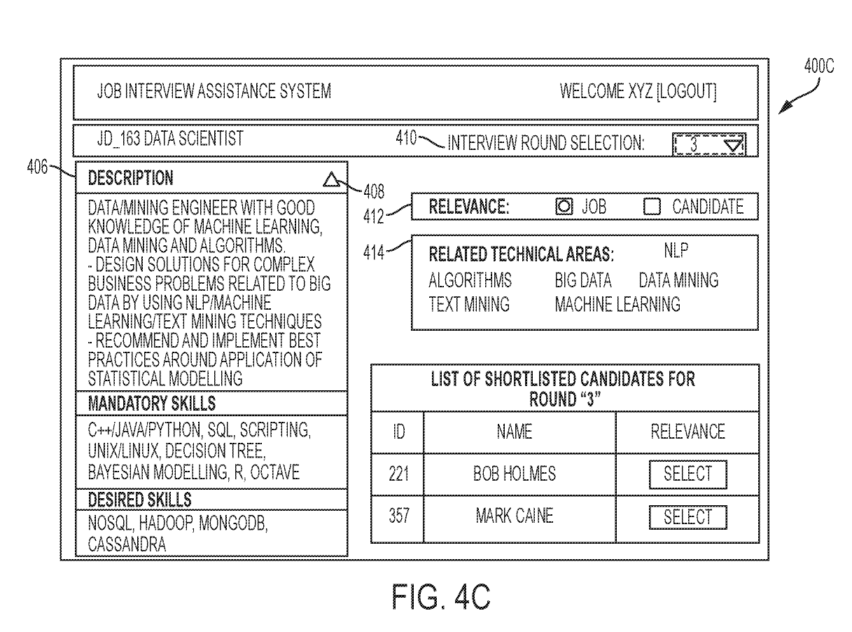

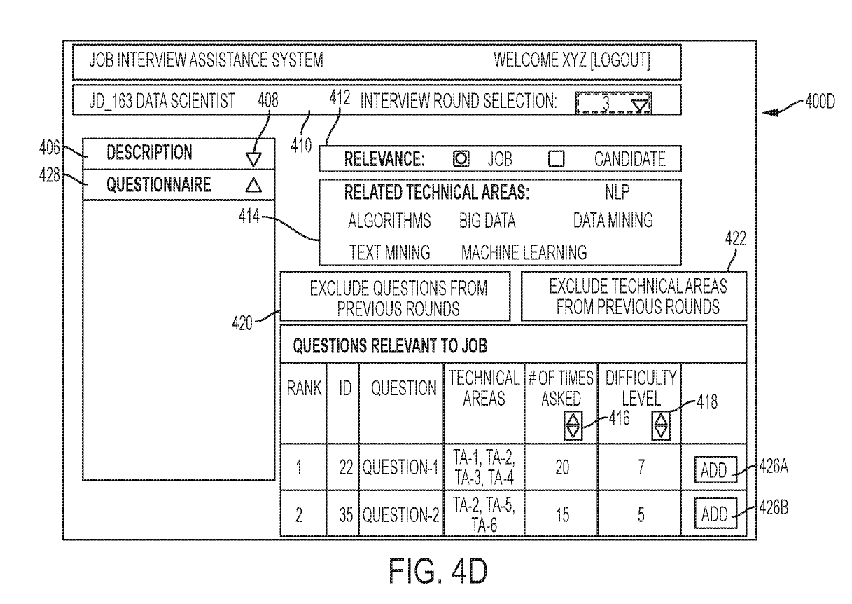

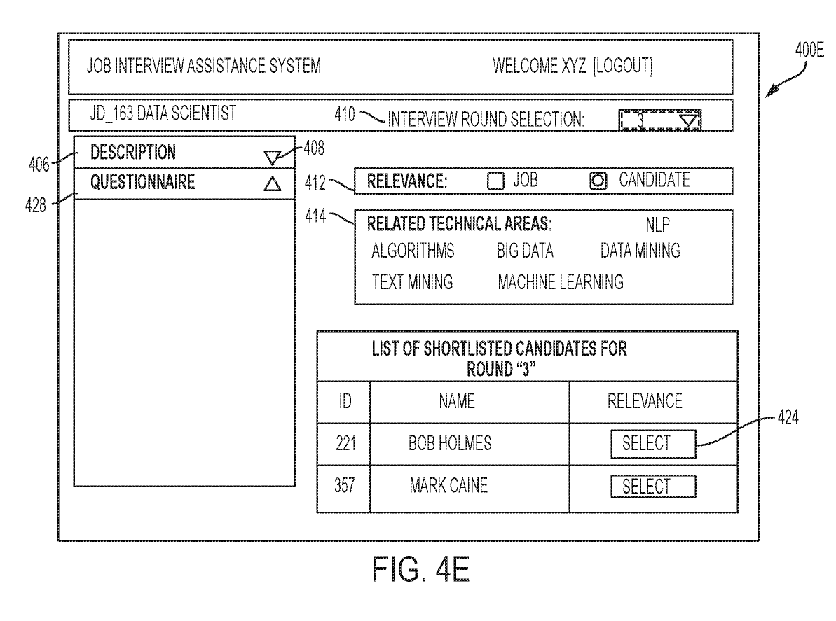

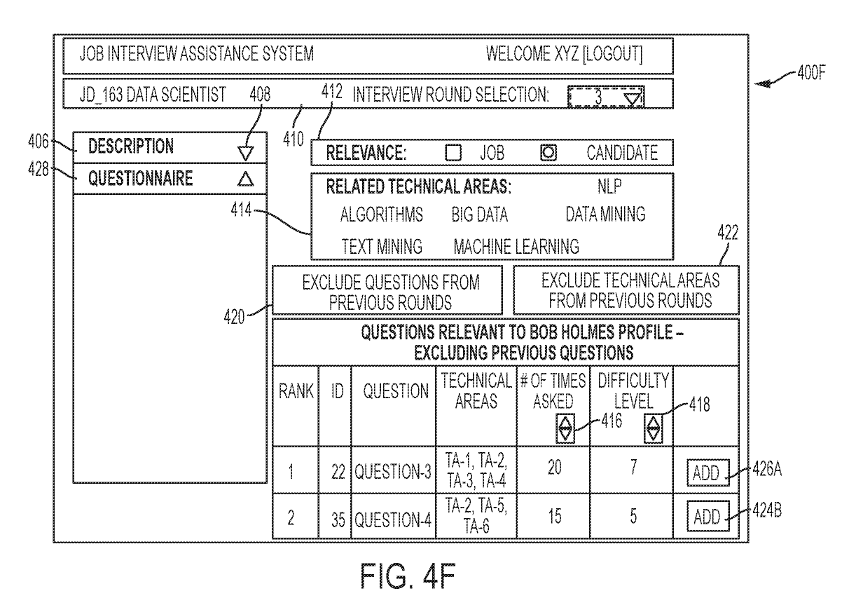

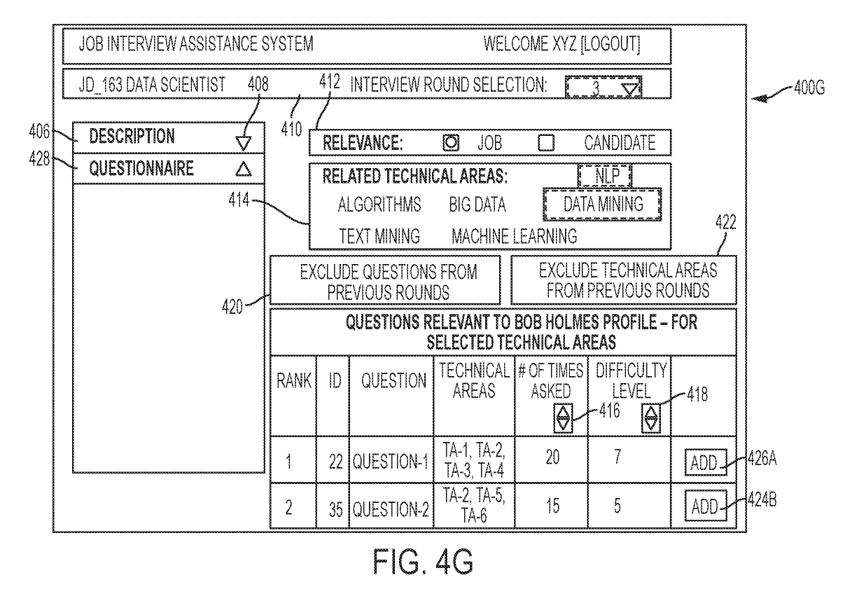

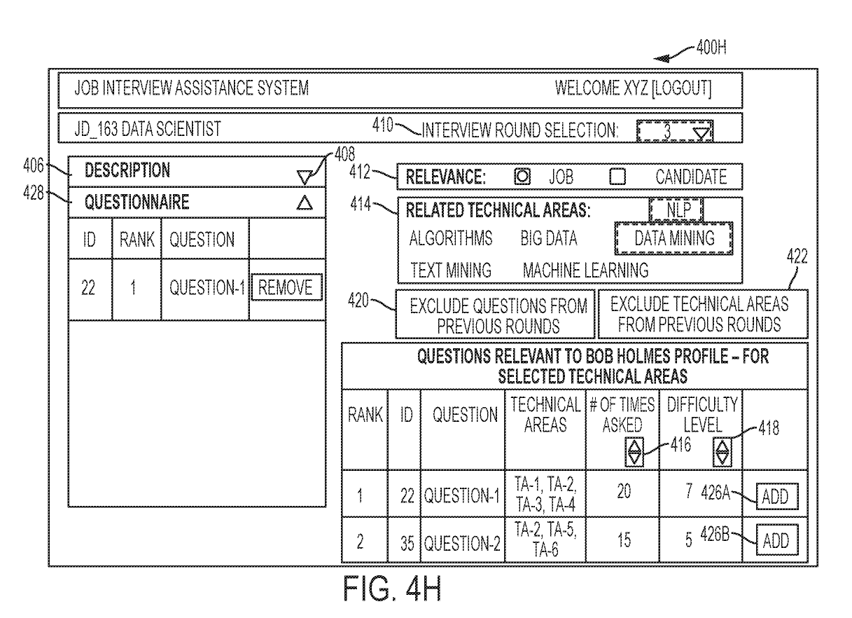

FIGS. 4A-4H are block diagrams that illustrate exemplary graphical user interfaces for a job interview assistance system, in accordance with various embodiments of the disclosure. The graphical user interfaces are representative of interactions of an interviewer with the job interview assistance system on the interviewer-computing device 102. The purpose of such interactions are to identify a ranked plurality of questions for an interview based at least on one or more preferences of the interviewer. FIGS. 4A-4H are explained in conjunction with elements from FIG. 1, FIG. 2, and FIG. 3.

With reference to FIG. 4A, there is shown a block diagram that illustrates a graphical user interface (GUI) 400A displaying a logged-in page of the interviewer on the interviewer-computing device 102, in accordance with an embodiment. The GUI 400A may be displayed on a display screen of the interviewer-computing device 102. Prior to the display of the GUI 400A, the interviewer logs into the job interview assistance system using his/her user id and password. Thereafter, the processor 202 may present the GUI 400A to the interviewer, when the interviewer has logged in. The processor 202 may further be configured to present a list of scheduled interviews (denoted by 402) on the GUI 400A. The list of scheduled interviews (denoted by 402) may include one or more interviews that have been allocated to the interviewer for interviewing one or more first candidates. The GUI 400A may further display a job ID, a job title, one or more related areas, and one or more allotted rounds of interview for each of the one or more interviews. Further, the GUI 400A may include one or more links, such as “view list” (denoted by 404A and 404B), for the one or more interviews that may be utilized by the interviewer to view a ranked plurality of questions for each of the one or more interviews.

Further, in an embodiment, the interviewer may click on one of one or more job titles. For example, the interviewer clicks on a job title “Data Scientist”. In a response to the click on the job title “Data Scientist”, the processor 202 may be configured to present a GUI 400B displaying a description of the “Data Scientist” job. For example, the description of the “Data Scientist” job is shown at a left hand side panel (denoted by 406) of GUI 400B, as shown in FIG. 4B. The interviewer may click on a toggle arrow (denoted by 408) on the left hand side panel (denoted by 406) to close the left hand side panel (denoted by 406). The processor 202 may further be configured to include an interview round selection section (denoted by 410) on the GUI 400B. The processor 202 may further be configured to include a relevance section (denoted by 412) on the GUI 400B. The interviewer may utilize the relevance section (denoted by 412) on the GUI 400B to provide his/her preferences to retrieve the plurality of questions for the interview associated with the job title “Data Scientist.”

Further, in an embodiment, the processor 202 may be configured to display one or more technical areas associated with the job title “Data Scientist” under a related technical areas section (denoted by 414) on the GUI 400B. The interviewer may select one or more of the one or more technical areas of the job title “Data Scientist” from the related technical areas section (denoted by 414) to retrieve the plurality of questions for the interview.

With reference to FIG. 4C, there is shown a block diagram that illustrates a GUI 400C displaying a list of first candidates, in accordance with an embodiment of the disclosure. In an embodiment, the interviewer may utilize the interview round selection section (denoted by 410) on the GUI 400B to select a current round of interview. For example, the interviewer selects a current round of interview to be as “3” in the interview round selection section (denoted by 410). In response to the selection of the current round of interview, the processor 202 may be configured to present the GUI 400C displaying the list of first candidates (i.e., candidates shortlisted for the round “3” interview).

After obtaining the list of first candidates, the interviewer may further provide his/her preferences for the retrieving the plurality of questions for the interview. The interviewer may select at least one section from one or more sections in the relevance section (denoted by 412) on the GUI 400C to provide his/her preferences. For example, the relevance section (denoted by 412) on the GUI 400C includes two sections i.e., “job-profile” and “candidate-profile.” The interviewer selects the “job-profile” section. In response to the selection, the processor 202 may further be configured to present a GUI 400D displaying the plurality of questions for the interview associated with the “Data Scientist” job. For a retrieved question in the plurality of questions, the processor 202 may be configured to display one or more of, but are not limited to, a rank of the question, an ID of the question, one or more technical areas of the question, a number of times the question has been asked in one or more previous interviews, and a difficulty level associated with the question. The GUI 400D may further facilitate the interviewer to sort questions in the plurality of questions based on the number of times the question has been asked in one or more previous interviews, a difficulty level associated with the question, and/or the like. For example, the interviewer may click on one or more of a first toggle arrow (denoted by 416) and a second toggle arrow (denoted by 418) to sort the questions in the plurality of questions. With reference to FIG. 4D, the first toggle arrow (denoted by 416) is associated with the number of times the question has been asked in one or more previous interviews and the second toggle arrow (denoted by 418) is associated with the difficulty level of the question. Further, in an embodiment, the processor 202 may include one or more filtering sections that may facilitate the interviewer to filter out one or more of the questions in the plurality of questions. For example, the GUI 400D includes a first filtering section (denoted 420) by to filter out questions from the plurality of questions that were asked in previous round of interviews. Further, the GUI 400D includes a second filtering section (denoted 422) to filter out questions from the plurality of questions that include one or more technical areas from the previous round of interviews.

In an embodiment, the interviewer may have selected the “candidate-profile” section instead of the “job-profile” section in the relevance section (denoted by 412) on the GUI 400C. In such a case, the interviewer may view the list of first candidates based on at least the selection of the current round of interview as shown in FIG. 4E.

With reference to FIG. 4E, there is shown a GUI 400E displaying the list of first candidates, in accordance with an embodiment of the disclosure. The list of first candidates includes one or more first candidates who have been selected for the current round of interview (e.g., round “3”). Further, the GUI 400E may facilitate the interviewer to retrieve the plurality of questions for the interview based on the “candidate-profile” selected by the interviewer. For example, the interviewer may click on a name of a first candidate (e.g., Bob Holmes) in the list of first candidates. Thereafter, the processor 202 may display the candidate-profile of the selected first candidate (e.g., Bob Holmes) on the GUI 400E. Further, the interviewer may click on a select tab (denoted by 424), pertaining to the selected first candidate, to view the plurality of questions for the interview with the selected first candidate. In a response to the selection, the processor 202 may be configured to present a GUI 400F, as shown in FIG. 4F, displaying the plurality of questions that are relevant from the perspective of the candidate-profile of the selected first candidate (e.g., Bob Holmes).

As discussed above, the processor 202 may include the one or more filtering sections that may facilitate the interviewer to filter out the one or more of the questions in the plurality of questions. For example, the GUI 400F includes the first filtering section (denoted 420) to filter out questions from the plurality of questions that were asked in previous round of interviews. Further, the GUI 400F includes the second filtering section (denoted 422) to filter out questions from the plurality of questions that include one or more technical areas from the previous round of interviews. Based on at least the selection of the one or more filtering sections by the interviewer, the processor 202 may filter out the one or more questions, from the plurality of questions, that had been already asked to the selected first candidate (e.g., Bob Holmes) in the previous round of interviews. Thereafter, the processor 202 may display the one or more questions in the plurality of questions that may have not been asked to the selected first candidate (e.g., Bob Holmes) in the previous round of interviews.

Further, in an embodiment, the processor 202 may be configured to present a GUI 400G, as shown in FIG. 4G, displaying a ranked plurality of questions based on the one or more technical areas selected by the interviewer. As discussed above, the processor 202 may display the one or more technical areas of the selected job title under the related technical areas section (denoted by 414). The interviewer may select one or more of the one or more technical areas of the job title “Data Scientist.” Based on the selection of the one or more technical areas (e.g., NLP and Data mining), the processor 202 may be configured to present the GUI 400G. The GUI 400G may display the ranked plurality of questions based on the selection of the one or more of the one or more technical areas of the job title “Data Scientist.”

Further, in an embodiment, the interviewer may click on one or more add to questionnaire tabs, such as “add” tabs (denoted by 426A and 426B) pertaining to each of the ranked plurality of questions, to select one or more of the ranked plurality of questions. In response to the selection, the processor 202 may present a GUI 400H, as shown in FIG. 4H, in accordance with an embodiment of the disclosure. The GUI 400H may include a section, such as a “questionnaire” section (denoted by 428), on the left hand side panel of the GUI 400H. The “questionnaire” section (denoted by 428) may display the selected one or more of the ranked plurality of questions to the interviewer.

The disclosed embodiments encompass numerous advantages. The disclosure provides methods and systems for ranking a plurality of questions for a job interview. The plurality of questions are selected from a repository of questions based on a preference of an interviewer. Further, the plurality of questions are ranked based on their relevance with respect to a job-profile and/or a candidate-profile. The disclosed methods further utilizes a difficulty level associated with each of the plurality of questions to rank the plurality of questions. The disclosed methods further utilizes a likelihood of selection of a question, from the plurality of questions, by an interviewer during an interview to rank the plurality of questions. The disclosed methods further include an interactive dashboard that may be utilized by the interviewer to view the ranked plurality of questions. The disclosed methods further facilitate the interviewer to exclude one or more questions that may have been already asked in one or more previous rounds of interviews. Therefore, the disclosed job interview assistance system provides an efficient, faster, automated, and accurate way organizing questions for an interview, thus, simplifying tedious tasks of interviewer during preparation of customized question for the interview.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for ranking questions for a job interview have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for ranking a plurality of questions for a job interview, the method comprising:
extracting, by one or more processors, the plurality of questions from a repository of questions, stored in a database server, based on at least a preference for the plurality of questions received from an interviewer-computing device;
for a question from the plurality of questions:
determining, by the one or more processors, a first score based on one or more of: one or more first metadata associated with a job-profile, and one or more second metadata associated with a candidate-profile;
determining, by the one or more processors, a second score based on a count of correct responses and a count of incorrect responses to the question associated with one or more previous interviews; and
determining, by the one or more processors, a third score based on at least a selection of the question from the plurality of questions by one or more interviewers in the one or more previous interviews;
ranking, by the one or more processors, the plurality of questions based on at least a weighted sum of the first score, the second score, and the third score associated with each of the plurality of questions; and
presenting, by the one or more processors, a user interface on a display screen of an interviewer-computing device displaying the ranked plurality of questions, based on at least the preference of an interviewer for the plurality of questions.

2. The method of claim 1 further comprising receiving, by one or more transceivers, a first input from the interviewer-computing device over a communication network, wherein the first input is indicative of at least a selection of the job-profile from one or more job-profiles by the interviewer.

3. The method of claim 2 further comprising receiving, by the one or more transceivers, a second input from the interviewer-computing device over the communication network, wherein the second input is indicative of the preference of the interviewer for the plurality of questions based on one or more of: the job-profile, and the candidate-profile of each of one or more first candidates who has applied for the job-profile.

4. The method of claim 3 further comprising extracting, by the one or more processors, the plurality of questions from a database server based on at least the second input.

5. The method of claim 1, wherein the first score is indicative of a relevance of the question with respect to one or more of: the job-profile, and the candidate-profile.

6. The method of claim 5 further comprising extracting, by the one or more processors, the one or more first metadata from the job-profile, wherein the one or more first metadata comprise at least one or more of: one or more skills associated with the question, one or more skills associated with the job-profile, a similarity of the question with a job title and a job role, one or more technical areas associated with the question, and one or more technical areas associated with the job-profile.

7. The method of claim 6 further comprising extracting, by the one or more processors, the one or more second metadata from the candidate-profile, wherein the one or more second metadata comprise at least one or more of: a domain of study of one or more first candidates, one or more courses taken by the one or more first candidates, a work history of each of the one or more first candidates, and skills and technical areas associated with one or more projects of the one or more first candidates.

8. The method of claim 1, wherein the second score is indicative of a difficulty level of the question.

9. The method of claim 8 further comprising updating, by the one or more processors, the second score based on at least a third input received from the interviewer-computing device, wherein the third input is indicative of a selection of one or more questions from the plurality of questions by the interviewer.

10. The method of claim 1, wherein the third score is indicative of a trend of the question asked by the one or more interviewers in the one or more previous interviews.

11. The method of claim 10 further comprising updating, by the one or more processors, the third score based on at least a fourth input received from the interviewer-computing device, wherein the fourth input is indicative of one or more responses pertaining to one or more questions provided by one or more first candidates.

12. A job interview assistance system, the system comprising:
one or more processors in a data processing unit, wherein the data processing unit is connected to a terminal device relating to a provider of data via a communication network, the one or more processors being configured to:
for a question from a plurality of questions:
determine a first score based on one or more of: one or more first metadata associated with a job-profile, and one or more second metadata associated with a candidate-profile;
determine a second score based on a count of correct responses and a count of incorrect responses to the question associated with one or more previous interviews; and
determine a third score based on at least a selection of the question from the plurality of questions by one or more interviewers in the one or more previous interviews;
rank the plurality of questions based on at least a weighted sum of the first score, the second score, and the third score associated with each of the plurality of questions; and
present a user interface on a display screen of an interviewer-computing device displaying the ranked plurality of questions, based on at least a preference of an interviewer for the plurality of questions.

13. The system of claim 12, wherein one or more transceivers are configured to receive a first input from the interviewer-computing device over the communication network, wherein the first input is indicative of at least a selection of the job-profile from one or more job-profiles by the interviewer.

14. The system of claim 13, wherein the one or more transceivers are further configured to receive a second input from the interviewer-computing device over the communication network, wherein the second input is indicative of the preference of the interviewer for the plurality of questions based on one or more of: the job-profile, and the candidate-profile of each of one or more first candidates who has applied for the job-profile.

15. The system of claim 14, wherein the one or more processors are further configured to extract the plurality of questions from a database server based on at least the second input.

16. The system of claim 12, wherein the first score is indicative of a relevance of the question with respect to at least one of: the job-profile, and the candidate-profile.

17. The system of claim 16, wherein the one or more processors are further configured to extract the one or more first metadata from the job-profile, wherein the one or more first metadata comprise at least one or more of: one or more skills associated with the question, one or more skills associated with the job-profile, a similarity of the question with a job title and a job role, one or more technical areas associated with the question, and one or more technical areas associated with the job-profile.

18. The system of claim 17, wherein the one or more processors are further configured to extract the one or more second metadata from the candidate-profile, wherein the one or more second metadata comprise at least one or more of: a domain of study of one or more first candidates, one or more courses taken by the one or more first candidates, a work history of each of the one or more first candidates, and skills and technical areas associated with one or more projects of the one or more first candidates.

19. The system of claim 12, wherein the second score is indicative of a difficulty level of the question.

20. The system of claim 19, wherein the one or more processors are further configured to update the second score based on at least a third input received from the interviewer-computing device, wherein the third input is indicative of a selection of one or more questions from the plurality of questions by the interviewer.

21. The system of claim 12, wherein the third score is indicative of a trend of the question asked by the one or more interviewers in the one or more previous interviews.

22. The system of claim 21, wherein the one or more processors are further configured to update the third score based on at least a fourth input received from the interviewer-computing device, wherein the fourth input is indicative of one or more responses pertaining to one or more questions provided by one or more first candidates.

23. A computer program product for use with a computer, the computer program product comprising a non-transitory computer readable medium, wherein the non-transitory computer readable medium stores a computer program code for ranking a plurality of question for a job interview assistance system, wherein the computer program code is executable by one or more processors to:
for a question from a plurality of questions:
determine a first score based on one or more of: one or more first metadata associated with a job-profile, and one or more second metadata associated with a candidate-profile of one or more first candidates;
determine a second score based on a count of correct responses to the question and a count of incorrect responses to the question provided by one or more second candidates in one or more previous interviews; and
determine a third score based on at least a selection of the question from the plurality of questions by one or more interviewers in the one or more previous interviews;
rank the plurality of questions based on at least a weighted sum of the first score, the second score, and the third score associated with each of the plurality of questions; and
present a user interface on a display screen of an interviewer-computing device displaying the ranked plurality of questions, based on at least a preference of an interviewer for the plurality of questions.
